(19) United States
(12) Patent Application Publication
(10) Pub. No.: US 2008/0109390 A1
(43) Pub. Date: May 8, 2008

(54) METHOD FOR DYNAMICALLY MANAGING A PERFORMANCE MODEL FOR A DATA CENTER

(76) Inventors: Gabriel G. Iszlai, Toronto (CA); Marin M.L. Litoiu, Toronto (CA); Charles Murray Woodside, Ottawa (CA); Tao Zheng, Toronto (CA)

Correspondence Address: IBM CORP (YA);C/O YEE & ASSOCIATES PC, P.O. BOX 802333, DALLAS, TX, 75380, US

(21) Appl. No.: 11/556,452

(22) Filed: Nov. 3, 2006

(51) Int. Cl. G06F 15/18

(52) U.S. Cl. 706/14

(57) ABSTRACT

An autonomic computing system for dynamically managing a performance model for a data center. Measured performance data for a data processing system and performance model performance data from a performance model of the data processing system are obtained from which is generated estimated performance data. Upon comparison, if a difference between the measured performance data and the estimated performance data falls within defined limits, the performance module in the performance model structure is identified as an accurate model. If the difference does not fall within defined limits, the estimated performance data, the model performance data, and the measured performance data is analyzed to estimate new performance parameters for the performance model structure. Responsive to estimating new performance parameters for the performance model structure, the performance model structure is updated with the estimated new performance parameters.

### BACKGROUND OF THE INVENTION

1. Field of the Invention

The present invention relates generally to an improved data processing system, and in particular to a computer implemented method, system, and computer program product for dynamically managing a performance model for a data center.

2. Description of the Related Art

An autonomic computing system is a system that exhibits self-management, freeing administrators of low-level task management while delivering an optimized system. In an autonomic computing system, an autonomic manager controls the parameters of a managed element, makes decisions about runtime changes in the managed element and its surrounding environment, and performs those changes. An administrator does not control the system directly; rather, the administrator defines general policies and rules that serve as an input for the self-management process. For instance, the goals of the autonomic manager may be to maintain performance parameters of the system within limits specified by service level objectives (SLOs), and it may accomplish the goals by (a) measuring performance parameters of the system, such as response time, utilization, throughput, and workload, (b) comparing the measured parameters time with those specified SLO, and, (c) if the measured performance parameters are not within the limits, making changes in the system to bring the parameters within SLO limits.

The type of changes made to the system may include the tuning of runtime performance parameters (e.g., threading level, cache size, number of sessions, and the like), workload balancing across many processing elements, and provisioning the system with more processing elements that share the workload. However, there are a number of problems which may arise when creating an autonomic manager that implements the above policies and controls the performance of the system. One problem may be the lack of quantitative assessment tools, which are needed to determine what performance parameters to change in the system to bring the parameters within SLO limits and by how much.

One example of a known autonomic computing system implementation is Tivoli Intelligent Orchestrator (TIO), in which utilization of a processing element is monitored by TIO, and if the utilization goes above a threshold, another processing unit is added to the system to adhere to SLO limits. However, there are two main drawbacks of the TIO method. First, while the TIO method monitors utilization, what matters for users is the response time of the system rather than the utilization. Even if there is a correspondence between the utilization and response time that was established before setting the utilization threshold, that correspondence may not hold at runtime due to many perturbations that can affect the system. Second, by monitoring the utilization, there may not be a way to dynamically determine how many processing elements to add to maintain the response time within the limits. By using a predetermined change increment (e.g., always add “1” to the processing unit), it may take several steps to provide the necessary capacity, which may introduce unacceptable delays in bringing the response time within SLO limits.

Known autonomic computing systems also may comprise performance modeling tools such as analytical queuing models that mimic the system from a performance point of view.

### SUMMARY OF THE INVENTION

The illustrative embodiments provide an autonomic computing system for dynamically managing a performance model for a data center. The autonomic computing system obtains measured performance data for a data processing system and model performance data from a model of the data processing system. Estimated performance data is generated based on the measured performance data and the model performance data. Upon comparison, if a difference between the measured performance data and the estimated performance data falls within defined limits, the performance module in the performance model structure is identified as an accurate model. If the difference does not fall within defined limits, the estimated performance data, the model performance data, and the measured performance data is analyzed to estimate new performance parameters for the performance model structure. Responsive to estimating new performance parameters for the performance model structure, the performance model structure is updated with the estimated new performance parameters.

### BRIEF DESCRIPTION OF THE DRAWINGS

The novel features believed characteristic of the illustrative embodiments are set forth in the appended claims. The illustrative embodiments, themselves, however, as well as a preferred mode of use, further objectives, and advantages thereof, will best be understood by reference to the following detailed description of an illustrative embodiment when read in conjunction with the accompanying drawings, wherein:

FIG. 1 is a pictorial representation of a data processing system in which the illustrative embodiments may be implemented;

FIG. 2 is a block diagram of a data processing system in which the illustrative embodiments may be implemented;

FIG. 3 is a block diagram of an exemplary autonomic manager with which the illustrative embodiments may be implemented;

FIG. 4 is a diagram illustrating the exemplary operations of a model estimator in accordance with the illustrative embodiments;

FIG. 5 is a diagram illustrating exemplary components with which the illustrative embodiments may be implemented and their interactions;

FIG. 6A is an XML representation of data describing an exemplary model and load in accordance with the illustrative embodiments;

FIG. 6B is an XML representation of data describing exemplary data estimated by the solver in accordance with the illustrative embodiments;

FIG. 6C is an XML representation of data describing exemplary data measured by the data acquisition engine in accordance with the illustrative embodiments;

FIG. 6D is an XML representation of data describing exemplary estimated parameters and arrival rates for a model in accordance with the illustrative embodiments;

FIG. 7 is a graph illustrating measured response time and estimated response time for several exemplary workloads over a period of time in accordance with the illustrating embodiments; and

FIG. 8 is a flowchart of a process for dynamically managing a performance model for a data center in accordance with the illustrative embodiments.

### DETAILED DESCRIPTION OF THE PREFERRED EMBODIMENT

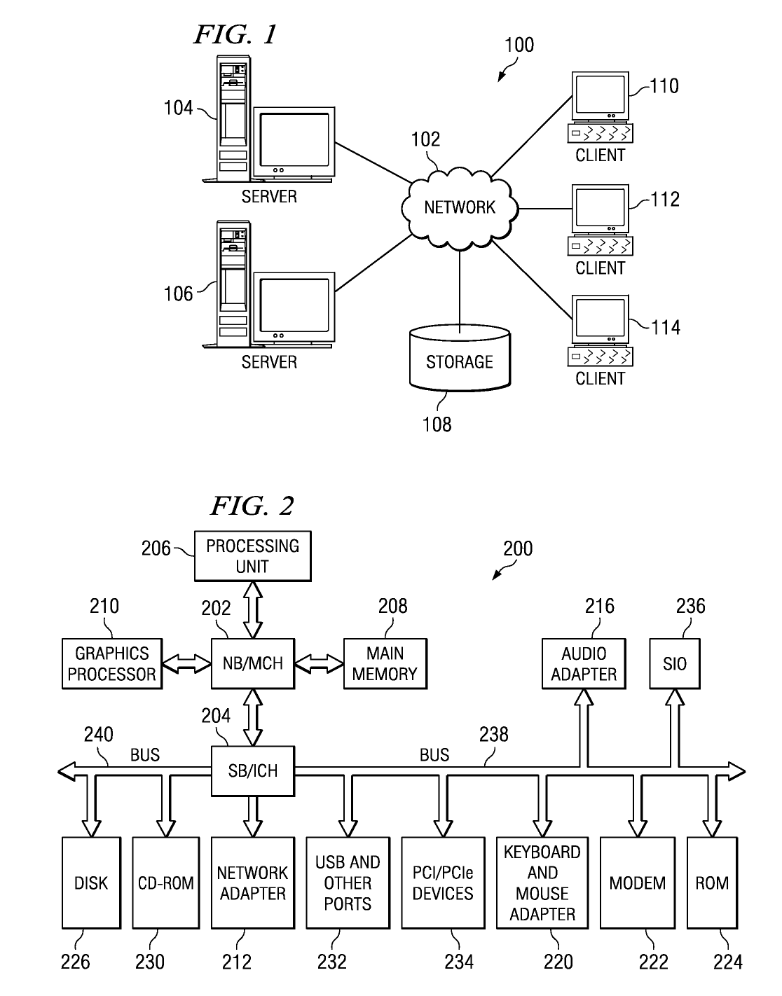

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

With reference now to the figures, FIG. 1 depicts a pictorial representation of a network of data processing systems in which illustrative embodiments may be implemented. Network data processing system 100 is a network of computers in which embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments.

With reference now to FIG. 2, a block diagram of a data processing system is shown in which illustrative embodiments may be implemented. Data processing system 200 is an example of a computer, such as server 104 or client 110 in FIG. 1, in which computer usable code or instructions implementing the processes may be located for the illustrative embodiments.

In the depicted example, data processing system 200 employs a hub architecture including a north bridge and memory controller hub (MCH) 202 and a south bridge and input/output (I/O) controller hub (ICH) 204. Processing unit 206, main memory 208, and graphics processor 210 are coupled to north bridge and memory controller hub 202. Processing unit 206 may contain one or more processors and even may be implemented using one or more heterogeneous processor systems. Graphics processor 210 may be coupled to the MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) ports and other communications ports 232, and PCI/PCIe devices 234 are coupled to south bridge and I/O controller hub 204 through bus 238, and hard disk drive (HDD) 226 and CD-ROM drive 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processing unit 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java programs or applications executing on data processing system 200. Java and all Java-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

The illustrative embodiments provide a computer implemented method, system, and computer program product or dynamically managing a performance model for a data center. In particular, the illustrative embodiments provide a performance model, which comprises a mathematical construct that mimics a system from a performance point of view, and a model estimator, which provides a programmatic method of building the performance model. The performance model and the model estimator are used concurrently to identify and implement quantitative changes in the system. In this manner, the use of the performance model in conjunction with the model estimator allows for programmatically determining performance parameters to change in a system, as well as estimating the results and magnitude of implementing those parameter changes. Examples of performance parameter changes may include, but are not limited to, changing the number of threads in use to accommodate the number of users, adding another server to the cluster to balance system loads, adding another instance of an application, and the like.

In one particular implementation, the illustrative embodiments may be implemented as part of Tivoli Intelligent Orchestrator (TIO), which is a product available from International Business Machines Corporation. Tivoli and various Tivoli derivatives are trademarks of International Business Machines Corporation in the United States, other countries, or both. The illustrative embodiments may also be implemented in any system which shares computing resources, such as a networked computing system or a cluster, or a computing system with multiple processors.

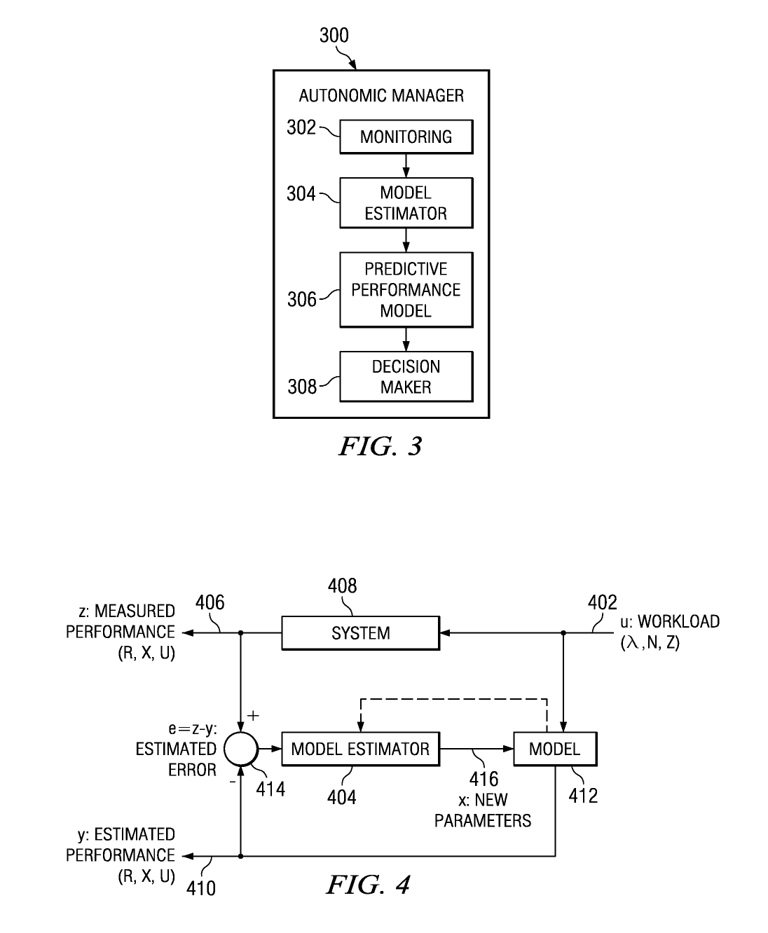

FIG. 3 is a block diagram of an exemplary autonomic manager with which the illustrative embodiments may be implemented. Autonomic manager 300 may be implemented in a data processing system, such as data processing system 200 in FIG. 2. In this illustrative example, autonomic manager 300 comprises a feedback-based internal structure of monitoring component 302, model estimator 304, predictive performance model 306, and decision maker 308.

Monitoring component 302 measures the performance of a system, such as, for example, network data processing system 100 in FIG. 1. Monitoring component 302 comprises a data store that collects the performance data of the system over a time period. Examples of monitoring component 302 include Tivoli Monitoring for Transaction Performance (TMTP) and Performance Monitoring Interface (PMI), which are products available from International Business Machines Corporation. The performance data measured by monitoring component 302 may include performance data such as resource response time, utilization, or throughput (e.g., arrival rate or number of users). Monitoring component 302 periodically samples the performance data and provides the data to model estimator 304.

Model estimator 304 builds predictive performance model 306, and predictive performance model 306 is used as a feedback for model estimator 304. Model estimator 304 estimates certain performance parameters of the system based on the measured performance data obtained from monitoring component 302 and the model performance data output from predictive performance model 306. Model estimator 304 may perform an estimation using any known optimal recursive data processing algorithm, such as a Kalman filter. A Kalman filter combines all available measurement data (system parameters measured by monitoring component 302), plus prior knowledge about the system and measuring devices (model parameters output by predictive performance model 306), to produce an estimate of the desired parameters in such a manner that the estimation error covariance is minimized statistically. In situations where some parameters of the system are not measured by monitoring component 302 to reduce overhead, model estimator 304 uses a predictor which estimates the values of these non-measured parameters of the system. Model estimator 304 also uses a corrector component which, based on a comparison of the measured real system performance data and the model performance data, corrects the values of the estimated parameters in predictive performance model 306.

Decision maker 308 compares Service Level Objects (SLO) with the measured system and model performance data. If decision maker 308 determines that, based on the comparison, there is need to improve the performance of the system, decision maker 308 queries predictive performance model 306 to identify which processing element in the system needs to be tuned or provisioned with more hardware and how much provisioning or tuning should be done. Decision maker 308 then issues provisioning or tuning commands to the execution elements. The commands issued may be influenced by the local policies of decision maker 308. These policies may include references to upper limits on the number of the resources to be provisioned at any given time, the time intervals between two consecutive provisioning commands, etc.

FIG. 4 is a diagram illustrating the exemplary operations of a model estimator, such as model estimator 304 in FIG. 3, in accordance with the illustrative embodiments. For a particular workload (u) 402, model estimator 404 monitors measured performance output (z) 406 of system 408 and the measured performance output (y) 410 of predictive performance model 412. Predictive performance model 412 is an example of predictive performance model 306 in FIG. 3. As previously mentioned, the outputs are easily accessible measured values, such as resource response time (R), utilization (U), or throughput (X). Model estimator 404 compares measured performance output (z) 406 against the estimated performance output (y) 410. The difference between performance output (z) 406 and performance output (y) 410, is defined as estimation error (e) 414 and is used by model estimator 404 to estimate new parameters (x) 416 for the predictive performance model 412. The estimation of parameters (x) 416 is made with the goal of minimizing estimation error (e) 414, thereby allowing the model parameters to mimic the performance of the system as closely as possible. Estimated parameters (x) 416 may include parameters that are hard to measure in the system, like service times or the number of invocations between the components of the system, and which have a direct influence on the performance outputs. As shown, predictive performance model 412 has a predefined dependency between estimated parameters (x) 416 and measured performance output (y) 410. This dependency fits with the historical data as well as with the current measures. With estimated parameters (x) 416 and with workload (u) 402, model estimator 404 estimates new performance output (y) 410. New performance output (y) 410 and performance output (z) 406 are then compared and the process may be repeated in as many iterations as needed in order for the estimated performance data to converge with the measured performance data of the system.

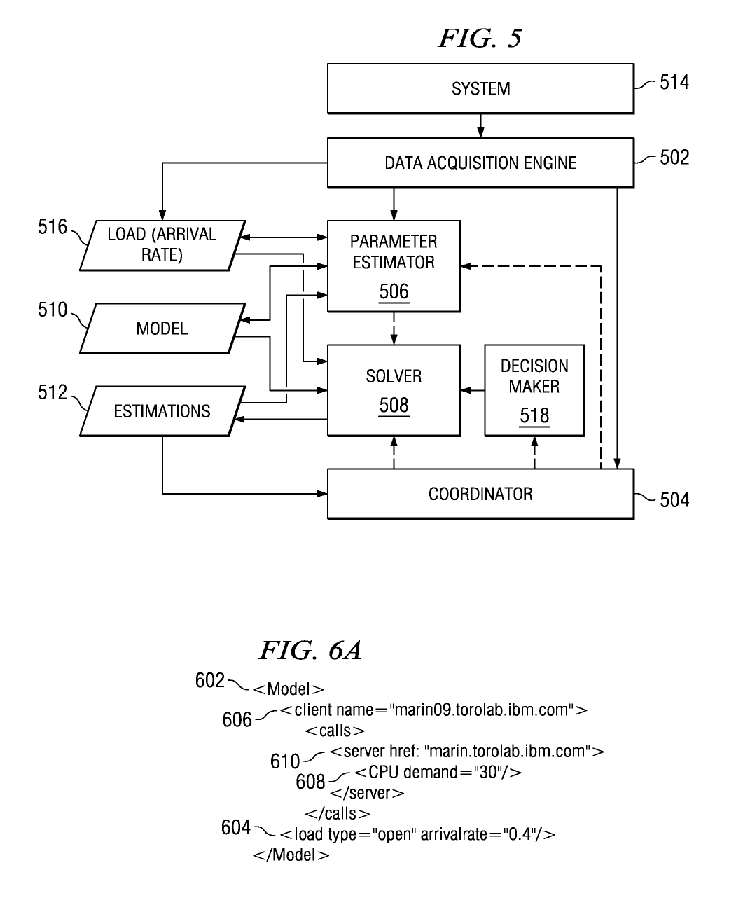

FIG. 5 is a diagram illustrating exemplary components in an autonomic computing system with which the illustrative embodiments may be implemented and their interactions. In FIG. 5, system 514 denotes a computing system such as network data processing system 100 in FIG. 1 or denoted system 408 in FIG. 4. All the other components in FIG. 5 are further details of monitoring component 302, model estimator 304, predictive performance model 306, and decision maker 308 in FIG. 3. In exemplary autonomic computing system 500, parallelograms denote data structures, and rectangles denote active elements, such as function. For instance, data acquisition engine 502 is a function within monitoring component 302 in FIG. 3, coordinator 504 and parameter estimator 506 are functions within model estimator 304 in FIG. 3, solver 508 and model structure 510 are subcomponents of the predictive performance model 306 in FIG. 3. Continuous lines are used to denote the data flow, and dashed lines denote the control flow. The goal of the component interactions is to make the performance data in estimations data structure 512 match the performance data measured from system 514.

Data acquisition engine 502 first collects performance data from system 514. If the collected performance data comprises workload data, data acquisition engine 502 updates load structure 516 with the workload data. Workload data may include performance data such as the number of users, user think times, arrival rate, or other workload data entities that one skilled in the art of modeling will recognize.

Coordinator 504 obtains the measured performance data from data acquisition engine 502 and invokes solver 508 to check if the performance data collected by data acquisition engine 502 matches the performance values estimated by solver 508. Solver 508 then receives an input of measured workload data from load structure 516 and an input of model data from model structure 510. When the inputs are received, solver 508 may combine the workload data against the performance model data using any well known performance modeling algorithm.

Based on the combination of the load and model inputs, solver 508 generates estimations data structure 512, which comprises estimated parameters for the system. Coordinator 504 then compares the measured performance data collected by data acquisition engine 502 with the estimated data from estimations data structure 512. If the difference between the measured performance data and the estimated data is within the limits set by the system administrator (e.g., less than 10% of measured performance data), then the current performance model in model structure 510 is determined to be an accurate model and the workload in load structure 516 is determined to be an accurate workload. Control may then be passed to decision maker 518, and decision maker 518 is able to now use the performance model in model 510 as a substitute for the real system.

If the difference between the measured performance data and the estimated data is not within the limits defined by the system administrator, parameter estimator 506 is launched. Parameter estimator 506 analyzes all of the measured data, including the estimated performance data, the model performance data, and the workload performance data. This analysis may include using well known algorithms such as a Kalman filter, for example, to estimate new parameters for model structure 510 and load structure 516. Parameter estimator 506 then updates model structure 510 with the new estimated parameters.

In should be noted that several iterations of the process described herein may be needed in order for parameter values estimated by solver 508 to converge or approach the parameter values measured by data acquisition engine 502. When the convergence occurs, coordinator 504 signals decision maker 518 that a good model of the system has been obtained. At this point, decision maker 518 may now use the model in model 510 as a substitute for the real system. Decision maker 518 may play “what if” scenarios with the model. These scenarios may include additions and removal of hardware and software resources and their effect on the overall system performance.

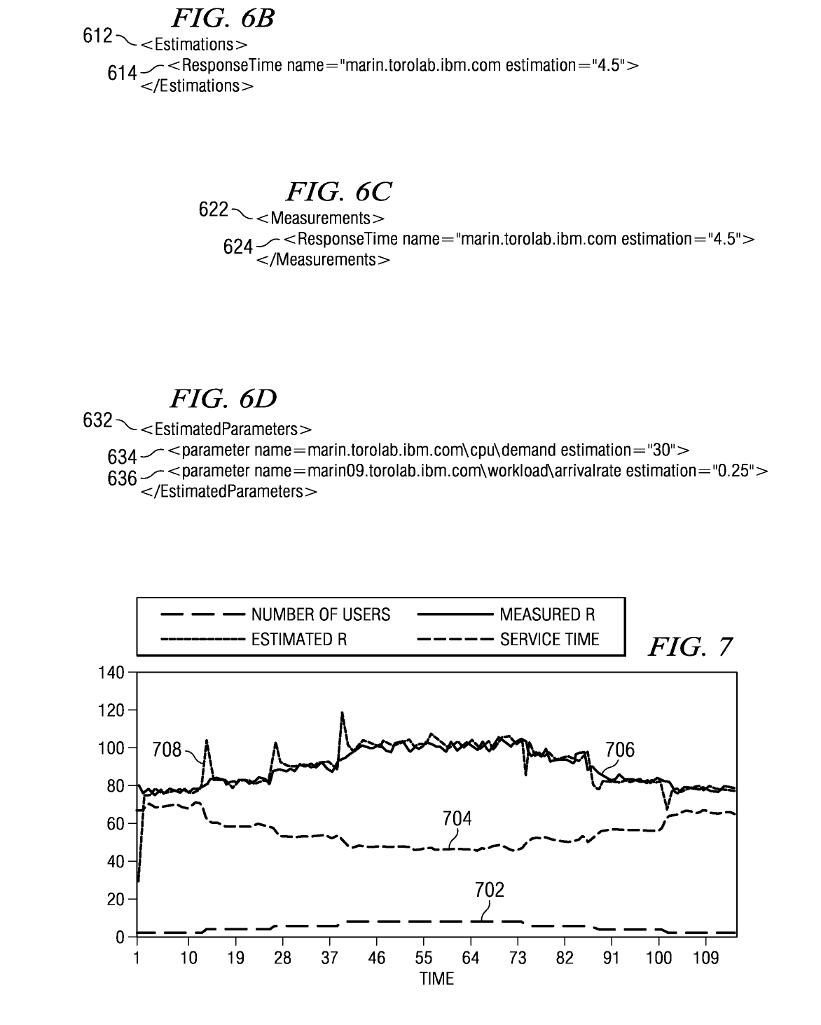

FIGS. 6A-6D are XML representations of exemplary data samples in accordance with the illustrative embodiments. In particular, FIG. 6A is an XML representation of data describing an exemplary model and load in accordance with the illustrative embodiments. Data sample 602 may be used as input to the solver comprising measured workload data (e.g., arrivalrate=“0.4” 604) from the load structure for a client (e.g., marin09.torolab.ibm.com 606), and input of estimated model data (e.g., demand=“30” 608) from the model structure for a server (e.g., marin.torolab.ibm.com 610).

FIG. 6B is an XML representation of data describing exemplary data estimated by the solver in accordance with the illustrative embodiments. Data sample 612 may be used by the solver to indicate estimated parameters of a resource. In this illustrative example, data sample 612 shows the estimated response time 614 of the server “marin.torolab.ibm.com”.

FIG. 6C is an XML representation of data describing exemplary data measured by the data acquisition engine in accordance with the illustrative embodiments. Data sample 622 may be used by the solver to indicate measured parameters of a resource. In this illustrative example, data sample 622 shows the measured response time 624 of the server “marin.torolab.ibm.com” which was measured by the data acquisitions engine.

FIG. 6D is an XML representation of data describing exemplary estimated demand and arrival rates for a model in accordance with the illustrative embodiments. Data sample 632 may be used by the parameter estimator to indicate estimated parameters of a resource. In this illustrative example, the estimated demand on the “marin.torolab.ibm.com” server 634 and the estimated response time for the client “marin09.torolab.ibm.com” 636 is shown.

FIG. 7 illustrates measured response time (real system) and the estimated response time (model) for several exemplary workloads over a period of time in graph form. The number of users in this illustrative example is shown by line 702. The estimated parameters used by the model estimator comprise the service time, which is shown by line 704. The measured response time of the real system for several workloads is shown by line 706. The estimated response time generated using the model is shown by line 708.

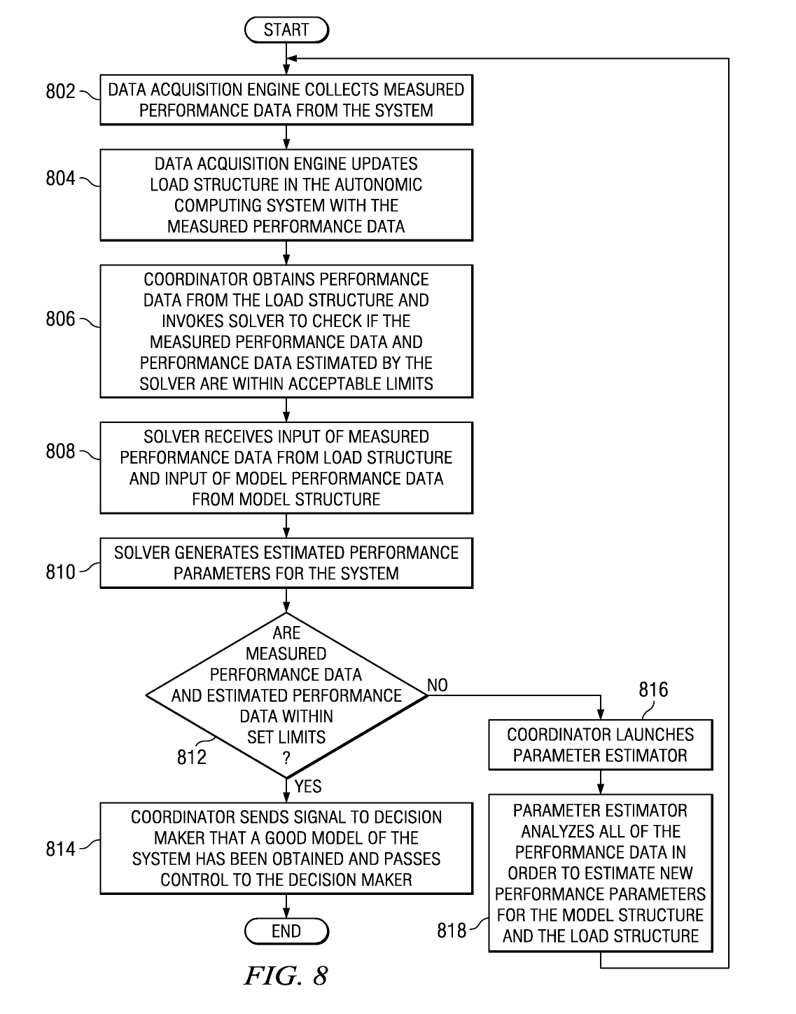

FIG. 8 is a flowchart of a process for dynamically managing a performance model for a data center in accordance with the illustrative embodiments. The process illustrated in FIG. 8 may be implemented using components in autonomic computing system 500 in FIG. 5. The process begins by having a data acquisition engine collect measured performance data from the system (step 802). The data acquisition engine then updates a load structure in the autonomic computing system with the measured performance data (step 804).

A coordinator component in the autonomic computing system then obtains the measured performance data from the load structure and invokes a solver component in order to check whether or not the measured performance data and the performance data estimated by the solver are within limits set by the system administrator (step 806). To determine if the values are within acceptable limits, the solver receives an input of measured performance data from the load structure and an input of model performance data from a model structure (step 808). The solver may combine the measured data and the model data using any well known performance modeling algorithm.

Based on the measured performance data and model performance data inputs, the solver then generates estimated performance data for the system (step 810). The coordinator then compares the measured performance data with the estimated performance data to determine if the measured performance data and the estimated performance data are within limits set by the system administrator (step 812). If the values are within acceptable limits (‘yes’ output of step 812), the performance model in the model structure is determined to be an accurate model and the workload in the load structure is determined to be an accurate workload. The coordinator signals the decision maker that a good model of the system has been obtained and control is passed to the decision maker (step 814). The decision maker is able to now use the model as a substitute for the real system, and the process terminates thereafter.

Turning back to step 812, if the measured performance data and the estimated performance data are not within the limits (‘no’ output of step 812), a parameter estimator is launched (step 816). The parameter estimator analyzes all of the performance data, including the estimated performance data, the model performance data, and the measured performance data, in order to estimate new performance parameters for the model structure and the load structure (step 818). The parameter estimator then updates the model structure with the new estimated parameters. The process may loop back to step 802 until the parameter values estimated by the solver (estimated parameter values) converge with the parameter values measured by the data acquisition engine (real system parameter values) as illustrated by the ‘yes’ output of step 812.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method in an autonomic computing system for dynamically managing a performance model, the computer implemented method comprising:
obtaining measured performance data for a data processing system;
obtaining model performance data from the performance model of the data processing system;
generating estimated performance data based on the measured performance data and the performance model performance data;
comparing the measured performance data with the estimated performance data;
responsive to a determination that a difference between the measured performance data and the estimated performance data falls within defined limits, identifying a performance module in the performance model structure as an accurate model; otherwise,
estimating new performance parameters for the performance model structure; and
updating the performance model structure with the estimated new performance parameters.

2. The computer implemented method of claim 1, wherein the obtaining, generating, comparing, analyzing, and updating steps are repeated until a determination is made that the difference between the measured performance data and the estimated performance data are within defined limits.

3. The computer implemented method of claim 1, further comprising:
using the performance model to mimic operations of the data processing system, wherein the operations include at least one of addition, modification, or removal of hardware and software resources in the data processing system.

4. The computer implemented method of claim 1, wherein obtaining measured performance data for a data processing system further comprises:
collecting measured performance data from the data processing system; and
storing the measured performance data in a load structure.

5. The computer implemented method of claim 1, wherein the obtaining steps are performed by a data acquisition engine in the autonomic computing system.

6. The computer implemented method of claim 1, wherein the generating, comparing, identifying, analyzing, and updating steps are performed by a model estimator in the autonomic computing system.

7. The computer implemented method of claim 4, wherein the measured performance data is obtained from the load structure in the autonomic computing system.

8. The computer implemented method of claim 1, wherein the model performance data is obtained from the performance model structure in the autonomic computing system.

9. The computer implemented method of claim 1, wherein the measured performance data includes at least one of a number of users, user think times, arrival rates, or a workload data entity.

10. An autonomic computing system for dynamically managing a performance model, the autonomic computing system comprising:
a bus;
a storage device connected to the bus, wherein the storage device contains computer usable code;
at least one managed device connected to the bus;
a communications unit connected to the bus; and
a processing unit connected to the bus, wherein the processing unit executes the computer usable code to obtain measured performance data for a data processing system, obtain model performance data from a performance model of the data processing system, generate estimated performance data based on the measured performance data and the performance model performance data, compare the measured performance data with the estimated performance data, identify a performance module in the performance model structure as an accurate model in response to a determination that a difference between the measured performance data and the estimated performance data falls within defined limits, otherwise estimate new performance parameters for the performance model structure, and update the performance model structure with the estimated new performance parameters.

11. A computer program product for dynamically managing a performance model, the computer program product comprising:
a computer usable medium having computer usable program code embodied thereon, the computer usable program code comprising:
computer usable program code for obtaining measured performance data for a data processing system;
computer usable program code for obtaining model performance data from a performance model of the data processing system;
computer usable program code for generating estimated performance data based on the measured performance data and the performance model performance data;
computer usable program code for comparing the measured performance data with the estimated performance data;
computer usable program code for identifying a performance module in the performance model structure as an accurate model in response to a determination that a difference between the measured performance data and the estimated performance data falls within defined limits; and
computer usable program code for estimating new performance parameters and updating the performance model structure with the estimated new performance parameters if the difference between the measured performance data and the estimated performance data does not fall within defined limits.

12. The computer program product of claim 11, wherein the computer usable program code for obtaining measured performance data, obtaining model performance data, generating estimated performance data, comparing the measured performance data with the estimated performance data, estimating new performance parameters, and updating the performance model structure is executed repeatedly until a determination is made that the difference between the measured performance data and the estimated performance data falls within defined limits.

13. The computer program product of claim 11, further comprising:
computer usable program code for using the performance model to mimic operations of the data processing system, wherein the operations include at least one of addition, modification, or removal of hardware and software resources in the data processing system.

14. The computer program product of claim 11, wherein the computer usable program code for obtaining measured performance data for a data processing system further comprises:
computer usable program code for collecting measured performance data from the data processing system; and
computer usable program code for storing the measured performance data in a load structure.

15. The computer program product of claim 11, wherein a data acquisition engine in the autonomic computing system obtains the measured performance data and the performance model performance data.

16. The computer program product of claim 11, wherein the computer usable program code for generating estimated performance data, comparing the measured performance data with the estimated performance data, identifying a performance module as an accurate model, estimating new performance parameters, and updating the performance model structure is executed by a model estimator in the autonomic computing system.

17. The computer program product of claim 14, wherein the measured performance data is obtained from the load structure in the autonomic computing system.

18. The computer program product of claim 11, wherein the performance model performance data is obtained from the performance model structure in the autonomic computing system.

19. The computer program product of claim 11, wherein the measured performance data includes at least one of a number of users, user think times, arrival rates, or a workload data entity.
